(19) United States
(12) Patent Application Publication
(10) Pub. No.: US 2021/0149471 A1
(43) Pub. Date: May 20, 2021

(54) METHOD FOR WAKING UP NOTEBOOK COMPUTER, COMPUTER ACCESSORY, AND COMPUTER SYSTEM

(71) Applicant: LUXSHARE-ICT CO., LTD., Taipei City (TW)

(72) Inventors: Sean P. O'Neal, Taipei City (TW); Erh-Tai Tsai, Taipei City (TW); Quan-Fei Ning, Taipei City (TW); Chih-Hsiung Chang, Taipei City (TW); Ya-Ling Huang, Taipei City (TW)

(73) Assignee: LUXSHARE-ICT CO., LTD., Taipei City (TW)

(21) Appl. No.: 17/159,666

(22) Filed: Jan. 27, 2021

(51) Int. Cl. G06F 1/3209; G06F 1/3228; G06F 1/26

(52) U.S. Cl. CPC G06F 1/3209; G06F 1/266; G06F 1/3228

(57) ABSTRACT

A method for waking up a notebook computer is adapted to a computer accessory. The notebook computer includes a host connector including a power receiving. The method includes setting a power management mode of the notebook computer to be awakened when connected to the external power, to switch a power state of the notebook computer from a waiting to be awakened state to a normal operation state; connecting the computer accessory to the host connector to establish a power connection through the power receiving pin and deliver an external power to the notebook computer; temporarily cutting off the external power by the computer accessory and then restoring the external power; when the power state of the notebook computer is the waiting to be awakened state, performing a wake-up operation with the notebook computer to switch to the power state to be the normal operation.

### BACKGROUND

### Technical Field

This disclosure relates to waking up a computer in sleeping state, in particular, to a method for waking up a notebook computer, a computer accessory, and a computer system.

### Related Art

In Advanced Configuration and Power Interface (ACPI) of a personal computer power state of the computer is able to be switched to sleep state so as to reduce power consumption. In sleep state, when a button or a switch of the computer is operated, the sleeping computer is triggered to perform a wake-up operation.

Regarding to a notebook computer, the user can use the BIOS to set the device to automatically trigger the wake-up operation to switch the power state to normal state after connecting the external power.

The aforementioned external power can be delivered by an AC-DC power adapter or a docking station. Generally, when using AC-DC power adapter or docking station, the user may decide to close the lid of the notebook computer, and then use the external display, keyboard and mouse. When the lid of the notebook computer is closed and the notebook computer is in sleep state, and needs to be awakened, the user has to manually disconnect the external power and then reconnect the external power, or the user has to open the lid of the notebook computer and operate button/switches of the notebook computer, to trigger the wake-up operation. Triggering wake-up operation in the aforementioned state is inconvenient, and the method of triggering wake-up operation needs to be changed.

### SUMMARY

In view of the foregoing problem, this disclosure provides a method for waking up a notebook computer, a computer accessory, and a computer system, to quickly and easily trigger the notebook to perform the wake-up operation.

At least on embodiment of this disclosure provide a method for waking up a notebook computer adapted to a computer accessory. The notebook computer at least includes a host connector, the host connector includes at least one power receiving pin, and the at least one power receiving pin is configured to receive an external power. The method comprises setting a power management mode of the notebook computer to be awakened when connected to the external power to switch a power state of the notebook computer from a waiting to be awakened state to a normal operation state; connecting the computer accessory to the host connector of the notebook computer, so as to establish a power connection through the at least one power receiving pin and deliver the external power to the notebook computer; temporarily cutting off the external power with the computer accessory and then restoring the external power; and when the power state of the notebook computer is the waiting to be awakened state, performing a wake-up operation with the notebook computer to switch to the power state to be the normal operation.

In at least one embodiment, the method further comprises disposing a triggering member on the computer accessory; wherein the triggering member is configured to trigger the computer accessory to temporarily stop outputting the external power and then restore the external power.

In at least one embodiment, the method further comprises disposing a triggering member on the computer accessory, and connecting the triggering member to the at least one power receiving pin; wherein the triggering member is configured to trigger an operation of cutting off and then restoring the power connection.

In at least one embodiment, the waiting to be awakened state is a Suspend-To-RAM state, a Suspend-To-Disk state, or a shutdown state.

In at least one embodiment, the method further comprises after performing the wake-up operation, determining whether an input device of the notebook computer is operated by the notebook computer; if the input device has not been operated for a preset time period, the notebook computer returns to the waiting to be awakened state.

One or more embodiments of this disclosure further disclose a computer accessory for connecting to a notebook computer. the host connector includes at least one power receiving pin, the host connector includes at least one power receiving pin, and the at least one power receiving pin is configured to receive an external power; and a power management mode of the notebook computer is set to be awakened when connected to the external power to switch a power state of the notebook computer from a waiting to be awakened state to a normal operation state; the computer accessory comprises an expansion connector and a power circuit. The expansion connector is configured to connect the host connector of the notebook computer; wherein the expansion connector includes at least one power delivery pin configured to connect the power receiving pin to establish a power connection and deliver the external power to the notebook computer through the power connection. The power circuit is electrically connected to the power delivery pin to provide the external power through the power delivery pin; wherein the power circuit includes a triggering member, the triggering member is configured to trigger the power circuit to temporarily stop outputting the external power and then restore the external power.

In at least one embodiment, the power circuit further includes a power delivery controller, wherein the power delivery controller is configured to connect an electric power source to generate the external power, the triggering member is electrically connected to the power delivery controller, and the triggering member is configured to trigger the power delivery controller to temporarily stop outputting the external power and then restore the external power.

In at least one embodiment, the power circuit further includes a power delivery controller, wherein the power delivery controller is configured to connect an electric power source to generate the external power, the triggering member is electrically connected to the power delivery controller and the at least one power delivery pin, and the triggering member is configured to cut off and then restore the power connection.

In at least one embodiment, the triggering member includes a push switch to be pressed to trigger the power circuit to temporarily stop outputting the external power and then restore the external power.

In at least one embodiment, the triggering member includes a capacitive button to be touched to trigger the power circuit to temporarily stop outputting the external power and then restore the external power.

In at least one embodiment, the power circuit further includes an input terminal, a triggered switch, and an output terminal, the input terminal is configured to connect an electric power source, the output terminal is connected to the at least one power delivery pin, the triggered switch is connected between the input terminal and the output terminal, the triggering member is electrically connected to the triggered switch and is configured to trigger the triggered switch to temporarily disconnect the output terminal and the input terminal and then reconnect the output terminal and the input terminal.

In at least one embodiment, the expansion connector is a Type-C USB connector.

One or more embodiments of this disclosure further disclose a computer system comprising a notebook computer and a computer accessory. The notebook computer at least includes a host connector, wherein the host connector includes at least one power receiving pin and the at least one power receiving pin is configured to receive an external power; wherein a power management mode of the notebook computer is set to be awakened to perform a wake-up operation when connected to the external power, to switch a power state of the notebook computer from a waiting to be awakened state to a normal operation state; The computer accessory comprises an expansion connector and a power circuit. The expansion connector is configured to connect the host connector of the notebook computer. The expansion connector includes at least one power delivery pin configured to connect the power receiving pin to establish a power connection and deliver the external power to the notebook computer. The power circuit is electrically connected to the power delivery pin to provide the external power. The power circuit includes a triggering member, the triggering member is configured to trigger the power circuit to temporarily stop outputting the external power and then restore the external power.

In at least one embodiment, the waiting to be awakened state is a Suspend-To-RAM state, a Suspend-To-Disk state, or a shutdown state.

In at least one embodiment, after the notebook computer performs the wake-up operation, the notebook computer determines whether an input device of the notebook computer is operated; if the input device has not been operated for a preset time period, the notebook computer returns to the waiting to be awakened state.

In at least one embodiment, the power circuit further includes a power delivery controller, wherein the power delivery controller is configured to connect an electric power source to generate the external power, the triggering member is electrically connected to the power delivery controller, and the triggering member is configured to trigger the computer accessory to temporarily stop outputting the external power and then restore the external power.

In at least one embodiment, the power circuit further includes a power delivery controller, wherein the power delivery controller is configured to connect an electric power source to generate the external power, the triggering member is electrically connected to the power delivery controller and the at least one power delivery pin, and the triggering member is configured to cut off and then restore the power connection.

In at least one embodiment, the triggering member includes a push switch to be pressed to trigger the power circuit to temporarily stop outputting the external power and then restore the external power.

In at least one embodiment, the triggering member includes a capacitive button to be touched to trigger the power circuit to temporarily stop outputting the external power and then restore the external power.

In at least one embodiment, the power circuit further includes an input terminal, a triggered switch, and an output terminal, the input terminal is configured to connect an electric power source, the output terminal is connected to the at least one power delivery pin, the triggered switch is connected between the input terminal and the output terminal, the triggering member is electrically connected to the triggered switch and is configured to trigger the triggered switch to temporarily disconnect the output terminal and the input terminal and then reconnect the output terminal and the input terminal.

In one embodiment or some embodiments of this disclosure, triggering wake-up operation only requires simple operation of the triggering member to generate a triggering signal, opening the lid of the notebook computer to operate buttons/switches is not required, and manually disconnecting and reconnecting the connection between the expansion connector and host connector are not required. Therefore, the approach to trigger the wake-up operation becomes more convenient. In addition, the approaches in one or more embodiments of this disclosure can be easily combined with a general AC-DC power adapter or docking station, and applicable to products from various venders.

### BRIEF DESCRIPTION OF THE DRAWINGS

This disclosure will become more fully understood from the detailed description given herein below for illustration only, and thus not limitative of this disclosure, wherein:

FIG. 1 illustrates a block diagram of the computer system according to a first embodiment of this disclosure.

FIG. 2 is a circuit block diagram of a computer accessory according to the first embodiment of this disclosure.

FIG. 3 and FIG. 4 are flowcharts of a method for waking up a notebook computer according to one or more embodiments of this disclosure.

FIG. 5 is a circuit block diagram of a computer accessory according to a second embodiment of this disclosure.

FIG. 6 is a circuit block diagram of a computer accessory according to a third embodiment of this disclosure.

FIG. 7, FIG. 8, and FIG. 9 are circuit block diagrams of a power circuit according to a fourth embodiment of this disclosure.

### DETAILED DESCRIPTION

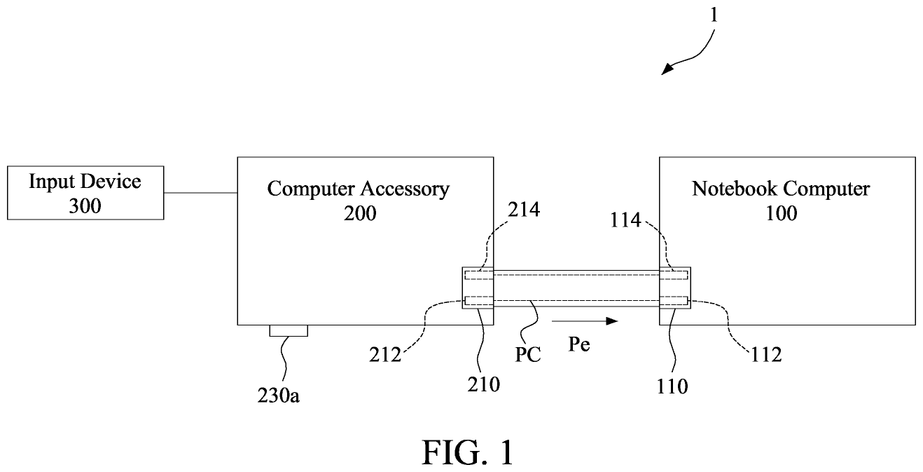

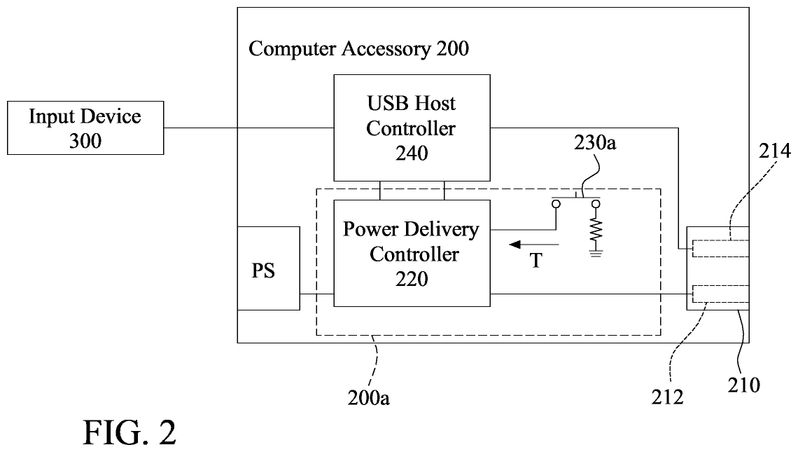

Referring to FIG. 1 and FIG. 2, a computer system 1 according to a first embodiment of this disclosure includes a notebook computer 100 and a computer accessory 200.

As shown in FIG. 1, the notebook computer 100 includes a host connector 110. The host connector 110 includes at least one power receiving pin 112, and the power receiving pin 112 is configured to receive an external power Pe. The external power Pe is transformed by power management circuit of the notebook computer 100, and delivered to electronic components of the notebook computer 100. A power management mode of the notebook computer 100 is able to be set to various modes for different power consumption requirements. In embodiments of this disclosure, the power management mode of the notebook computer 100 is able to be set to Wake on AC, so as to be awakened by external power Pe.

When the power management mode of the notebook computer 100 is set to Wake on AC, and the notebook computer 100 not connected to the external power Pe is in a waiting to be awakened state, the notebook computer 100 will performs a wake-up operation if the notebook computer 100 is being connected to the external power Pe, so as to switch a power state of the notebook computer 100 from the waiting to be awakened state to a normal operation state.

As shown in FIG. 1 and FIG. 2, the computer accessory 200 is configured to connect the notebook computer 100. The computer accessory 200 includes an expansion connector 210 and a power circuit 200a.

As shown in FIG. 1 and FIG. 2, the expansion connector 210 is configured to connect the host connector 110 of the notebook computer 100. In different embodiments, the computer accessory 200 is an independent assembly, and the expansion connector 210 connects the host connector 110 through a cable. In different embodiments, the computer accessory 200 is a dock station for the notebook computer 100 mounted thereon. The expansion connector 210 and the host connector 110 are male and female connectors directly connecting each other. In at least one embodiment, the expansion connector 210 is a Type-C USB connector, and the host connector 110 is another Type-C USB connector.

As shown in FIG. 1 and FIG. 2, the expansion connector 210 includes at least one power delivery pin 212. The power delivery pin 212 is configured to connect the power receiving pin 112 to establish a power connection PC and deliver the external power Pe to the notebook computer 100 through the power connection PC.

As shown in FIG. 2, the power circuit 200a is electrically connected to the power delivery pin 212 to provide the external power Pe through the power delivery pin Pe. The power circuit 200a further includes a triggering member 230a. The triggering member 230a is configured to trigger the power circuit 200a to temporarily stop outputting the external power Pe and then restore the external power Pe.

As shown in FIG. 1 and FIG. 2, the power management mode of the notebook computer 100 is set to Wake on AC and the notebook computer 100 enters the waiting to be awakened state. If the notebook computer 100 enters the waiting to be awakened state with continuously receiving the external power Pe, the notebook computer 100 keeps in the waiting to be awakened state as long as the external power Pe be unchanged. In Advanced Configuration and Power Interface (ACPI) the waiting to be awakened state includes a Suspend-To-RAM state (S3), a Suspend-To-Disk state (S4), and a shutdown state (S5).

When the power circuit 200a temporarily stops outputting the external power Pe and then restores the external power Pe, the notebook computer 100 is triggered to perform the wake-up operation to switch the power state of the notebook computer 100 from the waiting to be awakened state to the normal operation state. Through the computer accessory 200, the sleeping notebook computer 100 can be awakened by enabling the triggering member 230a to generate the trigger signal T, opening the lid of the notebook computer to operate buttons/switches, or manually disconnecting the host connector 110 and the expansion connector 210, is not required for performing the wake-up operation.

As shown in FIG. 2, the power circuit 200a further includes a power delivery controller 220. The power delivery controller 220 is configured to connect an electric power source PS to generate the external power Pe. The electric power source PS can be a source of AC power, or a battery or other energy storage device. The triggering member 230a is electrically connected to the power delivery controller 220, and configured to be pressed or touched to generate the trigger signal T to trigger the power delivery controller 220 to temporarily stop outputting the external power Pe and then restore the external power Pe.

In at least one embodiment, the triggering member 230a is a push switch, such as a normal open switch or a normal close switch, the push switch can be pressed to generate the trigger signal T to trigger the power delivery controller 220 to temporarily stop outputting the external power Pe and then restore the external power Pe. In different embodiments, the triggering member 230a is a capacitive button, the capacitive button can be touched to generate the trigger signal T to trigger the power delivery controller 220 to temporarily stop outputting the external power Pe and then restore the external power Pe. In different embodiments, the triggering member 230a is a signal generating module and controlled through software, micro controller, or wireless signal command, to generate the trigger signal T to trigger the power delivery controller 220 to temporarily stop outputting the external power Pe and then restore the external power Pe.

The aforementioned term “module” can be an application specific integrated circuit (ASIC), an electronic circuit, a microprocessor, a chip that executes one or more software or firmware programs, or a combinational logic circuit. The module is configured to execute various algorithms, transforms, and/or logical processes to generate one or more signals. When the module is implemented in software, a module can be readable instruction stored in memory for execution by the chip or the combinational logic circuit.

As shown in FIG. 2, in the first embodiment, an input device 300 is directly or indirectly connected to the notebook computer 100. In different embodiments, the input device 300 is directly connected to the notebook computer 100 and is mounted on a case of the notebook computer 100 to serve as a part of the notebook computer 100. In one or more embodiments, the input device 300 is, but not limited to, a keyboard, a mouse, a touch control pad, or other track input device. In the first embodiment, the computer accessory 200 further includes a USB host controller 240. The host connector 110 of the notebook computer 100 further includes one or more signal receiving pins 114. The expansion connector 210 of the computer accessory 200 further includes one or more signal outputting pin 214. The input device 300 is connected to the USB host controller 240, the USB host controller 240 is connected to the signal outputting pin 214, and the signal outputting pin 214 connects the signal receiving pin 114. The USB host controller 240 further connects the power delivery controller 220 to obtain required operation power and provide power to the input device 300. Through the USB host controller 240, the signal outputting pin 214, and the signal receiving pin 114, the input device 300 is indirectly connected to the notebook computer 100.

As shown in FIG. 1, after the notebook computer 100 performs the wake-up operation, the notebook computer 100 continuously determines whether the input device 300 is operated. If the input device 300 has not been operated for a preset time period (for example, 10 minutes), the notebook computer 100 returns to the waiting to be awakened state to reduce power consumption.

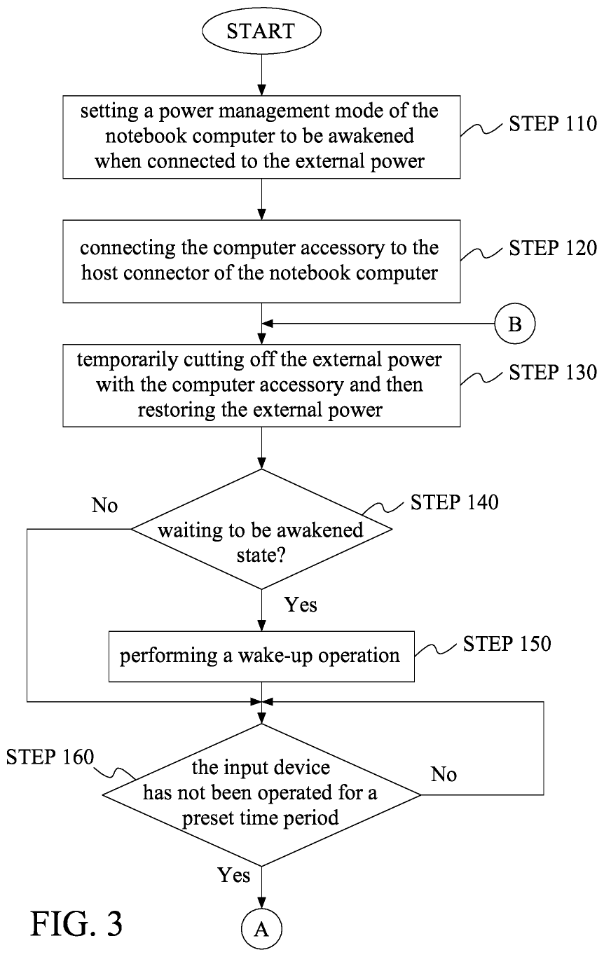

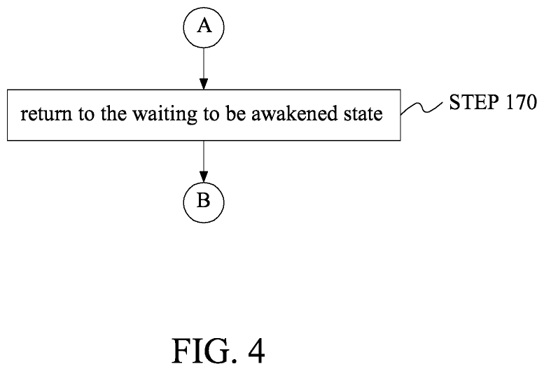

Referring to FIG. 3 and FIG. 4, based on one or more embodiment of this disclosure, this disclosure further discloses a method for waking up the notebook computer 100 adapted to the computer accessory 200, The method is described below.

As shown in FIG. 3, first, the power management mode of the notebook computer 100 is set to be awakened when connected to the external power Pe to switch a power state of the notebook computer 100 from a waiting to be awakened state to a normal operation state, as illustrated in STEP 110.

Next, the computer accessory 200 is connected to the host connector 110 of the notebook computer 100, so as to establish the power connection PC through the power delivery pin 212 and the power receiving pin 112, and deliver the external power Pe to the notebook computer 100 through the power connection PC, as illustrated in STEP 120.

The order of STEP 110 and STEP 120 may be exchanged. STEP 110 is performed when the power state of the notebook computer 100 is the normal operation state, and the notebook computer 100 is powered by a built-in battery or powered by the external power Pe after STEP 120 is performed in advance.

At this time, the power state of the notebook computer 100 may be the normal operation state, or the power state is switched to the waiting to be awakened state manually by the user or automatically by the notebook computer 100.

As shown in FIG. 3, the computer accessory 200 is triggered to temporarily cutting off the external power Pe and then restoring the external power Pe, as illustrated in STEP 130. In some embodiments, the triggering member 230a is pressed or touched to generate the trigger signal T to trigger the computer accessory 200 to temporarily cut off the external power Pe and then restore the external power Pe.

In some embodiment, when the computer accessory 200 is connected to the host connector 110 of the notebook computer 100, the power connection PC through the power delivery pin 212 and the power receiving pin 112 is established but the external power Pe is not delivered to the notebook computer 100 through the power connection PC until further triggering. For example, a default setting of the computer accessory 200 is not outputting the external power Pe whether the power connection PC is established or not (e.g., whether the computer accessary 200 is connected to the notebook computer 100 or not) until the triggering member 230a is triggered. In such case, the triggering member 230a is capable of (1) triggering the computer accessory 200 to temporarily cut off the external power Pe and then restore the external power Pe while the external power Pe is already outputted by the computer accessory 200; or (2) triggering the computer accessory 200 to output the external power Pe while the external power Pe is not yet outputted by the computer accessory 200.

When the power state of the notebook computer 100 is the normal operation state, the change of the external power Pe will not change the power state of the notebook computer 100. When the power state of the notebook computer 100 is the waiting to be awakened state, as illustrated in STEP 140, temporarily cutting off and then restoring the external power Pe triggers STEP 150 to perform the wake-up operation, so as to switch the power state of the notebook computer 100 to the normal operation state, as illustrated in STEP 150.

In some embodiments, as described above, STEP 130 is to trigger the power delivery controller 220 of the computer accessory 200 to temporarily stop outputting the external power Pe through the triggering member 230a disposed on the computer accessory 200, and then restore the external power Pe. In some embodiments, as described above, STEP 150 is to trigger the notebook computer 100 to perform the wake-up operation to switch the power state from the waiting to be awakened state to the normal operation state.

As shown in FIG. 3 and FIG. 4, after the notebook computer 100 performs the wake-up operation, the method is to continuously determine whether the input device 300 is operated by the notebook computer 100, as illustrated in STEP 160.

If the input device 300 has not been operated for a preset time period, for example 10 minutes, the notebook computer 100 is switched to return to the waiting to be awakened state to reduce power consumption, as illustrated in STEP 170.

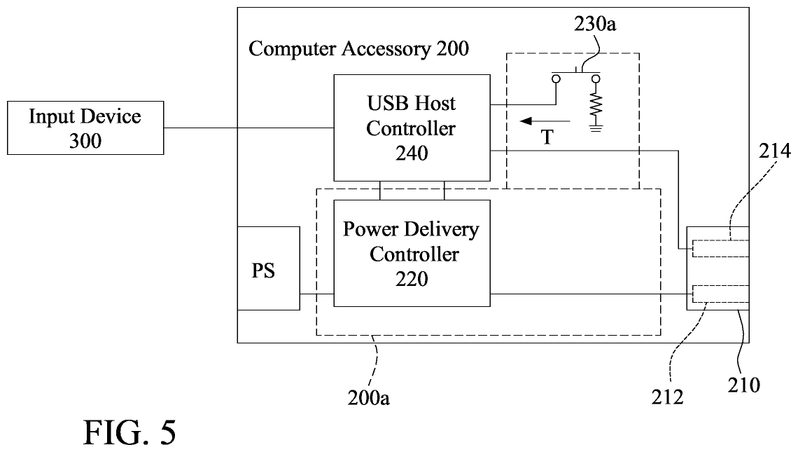

Referring to FIG. 1 and FIG. 5, a computer accessory 200 according to a second embodiment of this disclosure is provided for connecting to the notebook computer 100, to establish the computer system 1.

In the second embodiment, triggering member 230a is electrically connected to the USB host controller 240 to be indirectly connected to the power delivery controller 220. The triggering member 230a of the second embodiment is also used to be pressed or touched to generate the trigger signal T. the trigger signal T triggers the power delivery controller 220 to temporarily stop outputting the external power Pe and then restore the external power Pe. Therefore, in different embodiments, the triggering member 230a may be directly or indirectly connected to the power delivery controller 220.

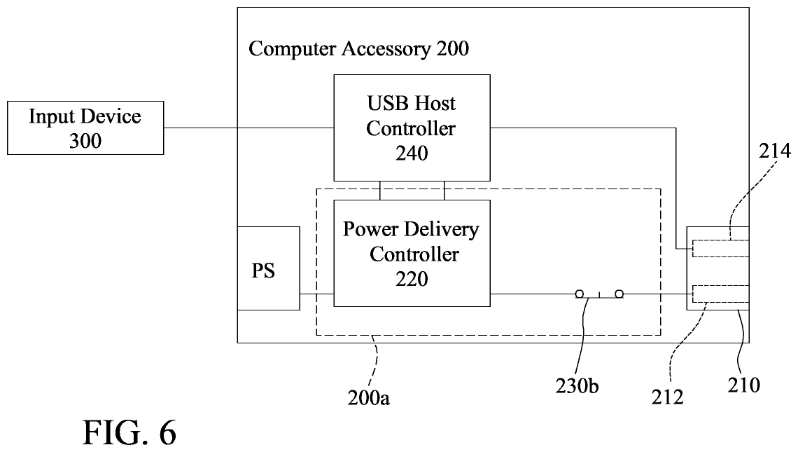

Referring to FIG. 1 and FIG. 6, a computer accessory 200 according to a third embodiment of this disclosure is provided for connecting to the notebook computer 100, to establish the computer system 1. In the third embodiment, the triggering member 230b is electrically connected to the power delivery controller 220, and also electrically connected to the power delivery pin 212. That is, the triggering member 230b is disposed between the power delivery controller 220 and the power delivery pin 212. The triggering member 230b may be a normal close switch. The triggering member 230b is configured to be pressed to cut off the connection between the power delivery controller 220 and the power delivery pin 212 and be released to restore the connection between the power delivery controller 220 and the power delivery pin 212, so as to temporarily stop outputting the external power Pe and then restore the external power Pe.

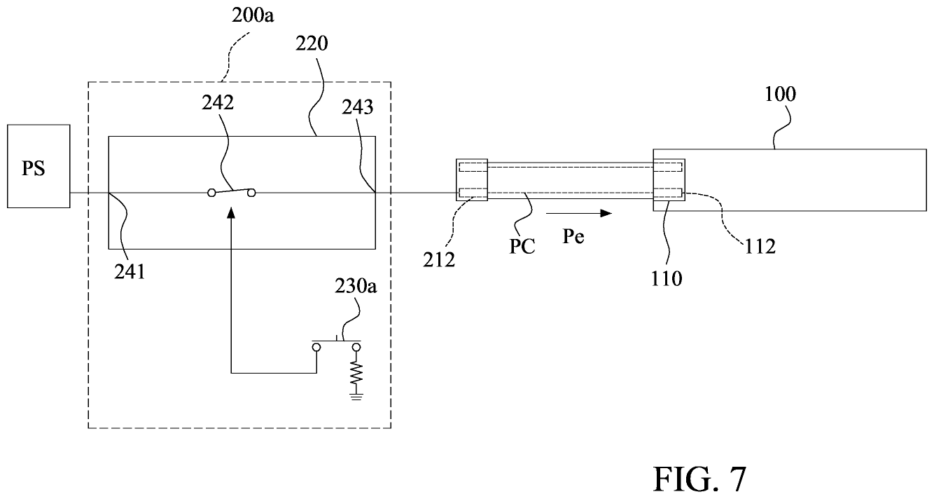

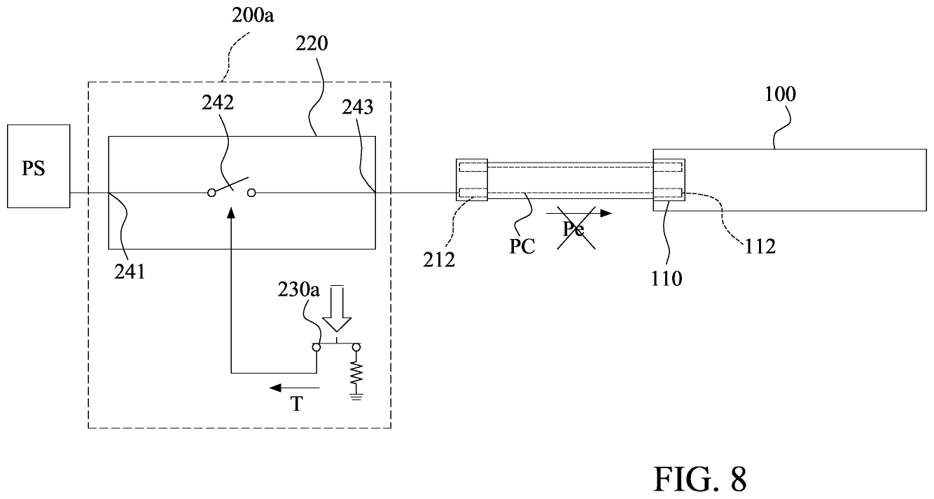

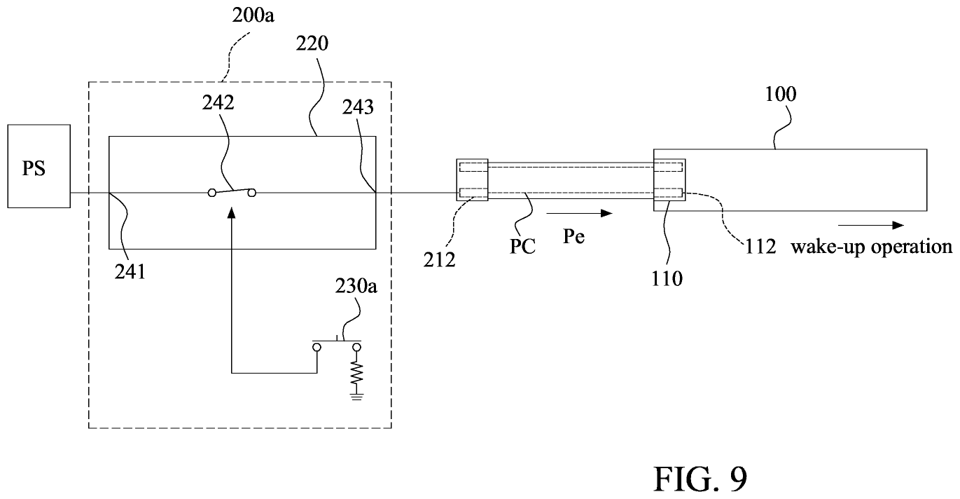

Referring to FIG. 7, FIG. 8, and FIG. 9, a power circuit 200a according to a second embodiment of this disclosure is adapted to the computer accessory 200 in one or more embodiment of this disclosure. The power circuit 200a includes an input terminal 241, a triggered switch 242, and an output terminal 243. The input terminal 241, the triggered switch 242, and the output terminal 243 are provided within the power delivery controller 220. In different embodiments, the input terminal 241, the triggered switch 242, and the output terminal 243 are connected in series, and then connected to the power delivery controller 220 in series. The input terminal 241 is configured to connect the electric power source PS, the output terminal 243 is connected to the power delivery pin 212, the triggered switch 242 is connected between the input terminal 241 and the output terminal 242, and the triggering member 230a is electrically connected to the triggered switch 242.

As shown in FIG. 7, when the power delivery pin 212 connects the power receiving pin 112, the power connection PC is established, and the power circuit 200a delivers the external power Pe to a power management circuit of the notebook computer 100 through the power connection PC.

As shown in FIG. 8, When the triggering member 230a is pressed or touched to generate the trigger signal T, the trigger signal T is transferred to the triggered switch 242, and the triggering signal T triggers the triggered switch 242 to temporarily disconnect the output terminal 243 and the input terminal 241, such that the power circuit 200a temporarily stops outputting the external power Pe.

As shown in FIG. 9, then the triggered switch 242 rapidly reconnects output terminal 243 and the input terminal 241, and the power circuit 200a restores the external power Pe.

At this time, if the power state of the notebook computer 100 in FIG. 8 is the waiting to be awakened state, temporarily disconnecting the external power Pe triggers the notebook computer 100 to perform the wake-up operation, so as to switch the power state to the normal operation state.

In one embodiment or some embodiments of this disclosure, Triggering wake-up operation only requires simple operation of the triggering member 230a, 230b to generate the triggering signal T, opening the lid of the notebook computer 100 to operate buttons/switches is not required. Manually disconnecting the host connector 110 and the expansion connector 210 is not required for performing the wake-up operation. For example, in a case that the computer accessory 200 is already connected to the notebook computer 100 in sleep state with the lid closed, the input device 300 connected, and an external display connected, the notebook computer 100 can be awakened to be operational simply by triggering the triggering member 230a, 230b without the needs of opening the lid or reconnecting the computer accessory 200. Therefore, the approach to trigger the wake-up operation becomes more convenient. In addition, the approaches in one or more embodiments of this disclosure can be easily combined with a general AC-DC power adapter or docking station, and applicable to products from various venders.

What is claimed is:

1. A method for waking up a notebook computer, adapted to a computer accessory, wherein the notebook computer at least includes a host connector, the host connector includes at least one power receiving pin, and the at least one power receiving pin is configured to receive an external power; the method comprising:
setting a power management mode of the notebook computer to be awakened when connected to the external power to switch a power state of the notebook computer from a waiting to be awakened state to a normal operation state;
connecting the computer accessory to the host connector of the notebook computer, so as to establish a power connection through the at least one power receiving pin and deliver the external power to the notebook computer;
temporarily cutting off the external power with the computer accessory and then restoring the external power; and
when the power state of the notebook computer is the waiting to be awakened state, performing a wake-up operation with the notebook computer to switch to the power state to be the normal operation state.

2. The method according to claim 1, further comprising disposing a triggering member on the computer accessory, wherein the triggering member is configured to trigger the computer accessory to temporarily stop outputting the external power and then restore the external power.

3. The method according to claim 1, further comprising disposing a triggering member on the computer accessory, and connecting the triggering member to the at least one power receiving pin; wherein the triggering member is configured to trigger an operation of cutting off and then restoring the power connection.

4. The method according to claim 1, wherein the waiting to be awakened state is a Suspend-To-RAM state, a Suspend-To-Disk state, or a shutdown state.

5. The method according to claim 1, further comprising after performing the wake-up operation, determining whether an input device of the notebook computer is operated by the notebook computer; if the input device has not been operated for a preset time period, the notebook computer returns to the waiting to be awakened state.

6. A computer accessory for connecting to a notebook computer, wherein the notebook computer at least includes a host connector, and the host connector includes at least one power receiving pin configured to receive an external power, and a power management mode of the notebook computer is set to be awakened when connected to the external power to switch a power state of the notebook computer from a waiting to be awakened state to a normal operation state; the computer accessory comprising:
an expansion connector, configured to connect the host connector of the notebook computer; wherein the expansion connector includes at least one power delivery pin configured to connect the power receiving pin to establish a power connection and deliver the external power to the notebook computer through the power connection; and
a power circuit, electrically connected to the power delivery pin to provide the external power through the power delivery pin; wherein the power circuit includes a triggering member, the triggering member is configured to trigger the power circuit to temporarily stop outputting the external power and then restore the external power.

7. The computer accessory according to claim 6, wherein the power circuit further includes a power delivery controller, wherein the power delivery controller is configured to connect an electric power source to generate the external power, the triggering member is electrically connected to the power delivery controller, and the triggering member is configured to trigger the power delivery controller to temporarily stop outputting the external power and then restore the external power.

8. The computer accessory according to claim 6, wherein the power circuit further includes a power delivery controller, wherein the power delivery controller is configured to connect an electric power source to generate the external power, the triggering member is electrically connected to the power delivery controller and the at least one power delivery pin, and the triggering member is configured to cut off and then restore the power connection.

9. The computer accessory according to claim 6, wherein the triggering member includes a push switch to be pressed to trigger the power circuit to temporarily stop outputting the external power and then restore the external power.

10. The computer accessory according to claim 6, wherein the triggering member includes a capacitive button to be touched to trigger the power circuit to temporarily stop outputting the external power and then restore the external power.

11. The computer accessory according to claim 6, wherein the power circuit further includes an input terminal, a triggered switch, and an output terminal, the input terminal is configured to connect an electric power source, the output terminal is connected to the at least one power delivery pin, the triggered switch is connected between the input terminal and the output terminal, the triggering member is electrically connected to the triggered switch and is configured to trigger the triggered switch to temporarily disconnect the output terminal and the input terminal, and then reconnect the output terminal and the input terminal.

12. The computer accessory according to claim 6, wherein the expansion connector is a Type-C USB connector.

13. A computer system, comprising:
a notebook computer, including a host connector; wherein the host connector includes at least one power receiving pin and the at least one power receiving pin is configured to receive an external power; wherein a power management mode of the notebook computer is set to be awakened to perform a wake-up operation when connected to the external power, to switch a power state of the notebook computer from a waiting to be awakened state to a normal operation state; and
a computer accessory, comprising:
an expansion connector, configured to connect the host connector of the notebook computer; wherein the expansion connector includes at least one power delivery pin configured to connect the power receiving pin to establish a power connection and deliver the external power to the notebook computer; and
a power circuit, electrically connected to the power delivery pin to provide the external power; wherein the power circuit includes a triggering member, the triggering member is configured to trigger the power circuit to temporarily stop outputting the external power and then restore the external power.

14. The computer system according to claim 13, wherein the waiting to be awakened state is a Suspend-To-RAM state, a Suspend-To-Disk state, or a shutdown state.

15. The computer system according to claim 13, wherein after the notebook computer performs the wake-up operation, the notebook computer determines whether an input device of the notebook computer is operated; if the input device has not been operated for a preset time period, the notebook computer returns to the waiting to be awakened state.

16. The computer system according to claim 13, wherein the power circuit further includes a power delivery controller, wherein the power delivery controller is configured to connect an electric power source to generate the external power, the triggering member is electrically connected to the power delivery controller, and the triggering member is configured to trigger the computer accessory to temporarily stop outputting the external power and then restore the external power.

17. The computer system according to claim 13, wherein the power circuit further includes a power delivery controller, wherein the power delivery controller is configured to connect an electric power source to generate the external power, the triggering member is electrically connected to the power delivery controller and the at least one power delivery pin, and the triggering member is configured to cut off and then restore the power connection.

18. The computer system according to claim 13, wherein the triggering member includes a push switch to be pressed to trigger the power circuit to temporarily stop outputting the external power and then restore the external power.

19. The computer system according to claim 13, wherein the triggering member includes a capacitive button to be touched to trigger the power circuit to temporarily stop outputting the external power and then restore the external power.

20. The computer system according to claim 13, wherein the power circuit further includes an input terminal, a triggered switch, and an output terminal, the input terminal is configured to connect an electric power source, the output terminal is connected to the at least one power delivery pin, the triggered switch is connected between the input terminal and the output terminal, the triggering member is electrically connected to the triggered switch and is configured to trigger the triggered switch to temporarily disconnect the output terminal and the input terminal and then reconnect the output terminal and the input terminal.
